(19) United States
(12) Patent Application Publication
(10) Pub. No.: US 2020/0076574 A1
(43) Pub. Date: Mar. 5, 2020

(54) SYSTEMS AND METHODS OF BLOCKCHAIN PLATFORM FOR RULE-BASED DE-CENTRALIZED ROLES AND CONTROL

(71) Applicant: 0Chain, LLC, San Jose, CA (US)

(72) Inventors: Thomas H Austin, San Jose, CA (US); Saswata Basu, San Jose, CA (US)

(73) Assignee: 0Chain, LLC, San Jose, CA (US)

(21) Appl. No.: 16/118,423

(22) Filed: Aug. 30, 2018

(51) Int. Cl. H04L 9/06; G06F 17/30; H04L 9/32; G06Q 20/06

(52) U.S. Cl. CPC H04L 9/0637; G06F 17/30377; G06Q 20/06; H04L 9/32; G06F 17/30371

(57) ABSTRACT

The systems and methods of a blockchain platform for de-centralized rule-based roles and control. A system and/or method on a blockchain platform, comprising: de-centralizing a transaction on the blockchain by communicating separately with a miner for operation and a blobber for application; inviting one or more rule-based actions to trigger the transaction from the miner or the blobber in response to a client request; receiving an action from the miner or the blobber; determining whether the action is one of the rule-based actions; rewarding the rule-based action from the miner or the blobber; discarding any action that is not rule-based; committing the transaction after confirming authentication of all the entities and verifying data integrity for the transaction.

If an Application Data Sheet (ADS) has been filed on the filing date of this application, it is incorporated by reference herein. Any applications claimed on the ADS for priority under 35 U.S.C. §§ 119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

### CROSS-REFERENCE TO RELATED APPLICATIONS

The present application is related to and/or claims the benefit of the earliest available effective filing date(s) from the following listed application(s) (the “Priority Applications”), if any, listed below (e.g., claims earliest available priority dates for other than provisional patent applications or claims benefits under 35 USC § 119(e) for provisional patent applications, for any and all parent, grandparent, great-grandparent, etc. applications of the Priority Application(s)). In addition, the present application is related to the “Related Applications,” if any, listed below.

### FIELD OF THE INVENTION

The present invention is in the technical field of cloud computing. More particularly, the present invention is in the technical field of blockchain platform. More particularly, the present invention is in the technical field of de-centralized roles and controls on a blockchain platform.

### BACKGROUND

Internet is a global computer network providing a variety of information and communication facilities, consisting of interconnected networks using standardized communication protocols. Internet is not owned by a single entity and it operates without a central governing body. The same principles of distributed governance were applied to digital currencies by providing ability to perform digital transactions that existed without support from any underlying institution. The digital ledger that records the transactions in a chain using a mathematical hierarchy is called a blockchain.

The current blockchain platform and related applications known to the industry fall short in multiple ways. The complex and computing intense mathematical calculations needed for the operations of the blockchain platform slow down the overall applications implemented on the blockchain platform. While the unique mathematical calculations allow for the openness and security of the transactions on the blockchain, there are certain practical limitations in using those same operations for applications. One cannot use the blockchain efficiently because of computing time and processing delay making each transaction slow to execute. As the blockchain grows, the processing time gets worse. A system that is not responsive is not desirable, has its downside and weakness on top of the existing time lag.

### SUMMARY OF THE INVENTION

The present invention is systems and methods of a blockchain platform for de-centralized rule-based roles and control. A system and/or method on a blockchain platform, comprising: de-centralizing a transaction on the blockchain by communicating separately with a miner for operation and a blobber for application; inviting one or more rule-based actions to trigger the transaction from the miner or the blobber in response to a client request; receiving an action from the miner or the blobber; determining whether the action is one of the rule-based actions; rewarding the rule-based action from the miner or the blobber; discarding any action that is not rule-based; committing the transaction after confirming authentication of all the entities and verifying data integrity for the transaction.

The system and/or method of blockchain platform, wherein the transaction involves lightning mode read request with Gdirect response from the blobber; and requesting reward from the miner at the end of the transaction.

The system and/or method of blockchain platform, wherein verifying data integrity includes commitment of the same Merkle root or leaf of the same Merkle root by two separate computing entities.

The system and/or method of blockchain platform, wherein rewarding the rule-based action is based on a counter associated with the client and the blobber from the committed transaction.

The system and/or method of blockchain platform, further comprising: receiving a challenge from one or more validators; verifying the blobber or the miner action based on the verification response of the challenge; self-regulating the transaction and the computing entities on the blockchain platform.

The system and/or method of blockchain platform, wherein the validator is a client.

The system and/or method of blockchain platform, wherein the transaction includes metadata for an associated application.

The system and/or method of blockchain platform, wherein the metadata includes metadata for a file system.

The system and/or method of blockchain platform, further comprising browsing the metadata for the associated application to lookup the transaction data.

The system and/or method of blockchain platform, further comprising: receiving a request from the client to re-assign a blobber from the committed transaction; committing a re-assigned transaction after confirming authentication of all the computing entities and verifying data integrity for the transaction.

### BRIEF DESCRIPTION OF THE DRAWINGS

The embodiments of this invention are illustrated by way of example and not limitation in the figures of the accompanying drawings, in which like references indicate similar elements and in which:

FIG. 1 shows a diagram illustrating an example of a system and method of a blockchain platform for rule-based de-centralized roles and control.

FIG. 2 shows an exploded view of a client computing system illustrating different subroutines, according to one embodiment.

FIG. 3 is an exploded view of a miner computing system illustrating different modules and functions, according to one embodiment.

FIG. 4 is an exploded view of a blobber computing system illustrating different modules and functions, according to one embodiment.

FIG. 5 shows the phases for lightning mode in a blockchain platform, according to one embodiment.

FIG. 6 shows a flowchart illustrating an example of a method of blockchain platform for rule-based de-centralized roles and control.

FIG. 7 is a schematic diagram of exemplary computing devices that can be used to implement the methods and systems disclosed herein, according to one embodiment.

### DETAILED DESCRIPTION OF THE INVENTION

The systems and methods of a blockchain platform for rule-based decentralized roles and control allows automated commitment of transactions by separating out operations and application data and actions. A client is an end-user with a computing device who initiates the requests and wants to commit transactions on the blockchain platform. A miner is the guard on the blockchain who is also performing the operations and administrative tasks on the blockchain. A blobber or a sharder uses a computing device that processes the applications on the blockchain platform. Separating out administrative operational work and application work to a different group of machines allows for greater specialization in the design and specifications of the machines, allowing for the blockchain platform to be optimized for fast transaction handling as well as efficient application data handling for given transaction types.

Computer security uses authentication and encryption as two mechanisms to secure digital work. Authentication is a method to help verify the identity of the interface that is making or processing requests on the computer. Encryption is a method that allows access to a digital work only when you have a specific key associated with that particular content. A person of ordinary skill in the art would understand that there are different well-established ways of authentication and encryption that can be implemented in the blockchain platform to support the rule-based decentralized roles and control. The application and operations framework on the blockchain platform are separated into micro-operations to allow for faster implementation and response times.

In one embodiment, a unique combination is requested from the computing devices participating in a transaction. For example, both the client and blobber commit to the same Merkle root calculated from the application data shared for the transaction. In another embodiment, the client does not commit the Merkle root. The bloober commits a Merkle leaf that is based on the Merkle root. Each block of application data has its own associated Merkle leaf. In one embodiment, the blockchain platform uses markers actually tied to Merkle leaves to commit the transaction. The advantage about this approach is that the blobber commits the Merkle root, but it has to match up with the leaves he got from the client. If the client tries to cheat, he will be detected by the blobber immediately (because the leaf and marker won't match). If the blobber tries to cheat, the leaves won't match the root he committed to the blockchain.

Challenge Protocol. In one embodiment, the blockchain platform uses challenge protocol to verify the Merkle root and leaves and catch blobbers who are cheating. In order to verify that a blobber is actually performing the application action, for example, storing the data, that they claim, the blockchain platform relies on the miners periodically issuing challenge requests to the blobbers. The challenge request also helps in rewarding the blobbers for storing files, even if the files are not accessed by any clients. When the blobber passes the challenge, they receive newly minted tokens. At a high level, the challenge protocol involves three phases: (1) The mining network randomly selects the data to be challenged. This phase also preemptively punishes the blobber for failing to provide the data. (2) Once a blobber has been challenged, the blobber sends their data to a subset of a randomly selected group of validators. This request includes a signed authorization from the blobber. (3) The validator writes a transaction to the blockchain indicating whether the test passed. This transaction also pays the validator and rewards the blobber if the test was successful. The selection of validators is a particular challenge. In particular, we are worried about two attacks: (i) In a chronyism attack, a blobber sends that data to a friendly validator who approves all challenges without attempting to validate the data. (ii) In an extortion attack, a validator demands additional compensation from the blobber in exchange for passing the challenge. The blockchain platform defends against these attacks by randomly selecting a set of V validators. In one embodiment, a client is also a validator. The first A validators to approve or reject the challenge are rewarded for their work. The setting of A and V help to tune the defenses against these attacks. The difference between these values must be narrow enough to make a successful cronyism attack unlikely, but high enough to prevent an extortion attack.

The mining network must initially post a transaction to the network randomly challenging a blobber to provide a block of data. This transaction must include: (i) The allocation of data challenged, identified by client id and data id. Note that this should implicitly identify which blobber is challenged. (ii) The index of the block of data within that allocation that the blobber must provide. In order to avoid any bias or collusion between miners and blobbers, the challenge is determined through the use of a veriable random function (VRF).

Conceptually, we can envision this challenge as a roulette wheel, where a blobber with more data would have more slices on the wheel. VRFs avoid the last actor problem, preventing any single miner from skewing the results unfairly. The VRF also determines the set of V validators that the blobber may contact to approve the challenge. The initial transaction preemptively punishes the blobber by deducting X coins, depending on the punishment desired. This approach removes any incentive for the blobbers to perform a denial-of-service attack against the enforcement mechanism. Additionally, this phase establishes a challenge ctr initially set to A. With each challenge, the value of A is reduced by one. Once this counter reaches zero, additional validations will be ignored. This setup encourages validators to respond to the challenge as quickly as possible; furthermore, it limits the overall payout to both the blobber and validators in case of collusion between the two parties.

Justification Phase.

Once challenged, the blobber must provide data to the group of validators. The blobber must provide each validator with: (i) the challenged block of data; (ii) a matching write_marker proving that the owner of the data desired this block of data to be stored; (iii) the log₂n nodes of the Merkle tree needed to reconstruct the Merkle root, but no other nodes on punishment of automatic failure. (iv) a signature from the blobber authorizing the challenge, called a challenge authorization receipt, which includes the challenge transaction and the id of the validator.

When the blobber contacts the validator, the validator verifies the blobber's signature and verifies that the data matches both the write_marker and the Merkle root. By knowing the number of blocks, the validator knows the path that should be provided, preventing the blobber from adjusting the tree shape to their advantage. If the blobber provides additional Merkle nodes beyond those needed to conduct the challenge, the validator automatically fails the test.

Judgement Phase.

In one embodiment, the blockchain platform ensures that the validator is economically incentivized to carry out the challenge, but indifferent to the result of the challenge. Once each validator has performed the test, they write a transaction to the blockchain containing: (i) a bit specifying whether the challenge was successful; (ii) the left and right subnodes of the Merkle root; (iii) payment to the validator for their work; (iv) a reward for the blobber, if the challenge was successful; (v) the blobber's challenge authorization receipt to conduct the challenge.

In one embodiment, the subnodes of the Merkle root serve as proof that the validator conducted the challenge. Since providing both subnodes would be grounds for failing, the bloober will not provide both. Therefore, the validator must have calculated one of the two nodes. A validator might be tempted to automatically fail the blobber's challenge since that gives an advantage in writing the first transaction to the blockchain. However, since the validator cannot be paid without the challenge authorization receipt from the blobber, the blobber can prevent the blobber's attack in future transactions. If the validator becomes known for this attack, other blobbers may refuse to authorize challenges with that validator. The blobber's total reward is X+Y tokens, where X is the amount of coins previously taken from the blobber and Y is their additional reward. Therefore, each transaction reward the blobber with (X+Y)/A.

Block Level Versus Application Level Protocol.

The open systems interconnection defines seven layers for interconnection between the layers including physical, data-link, network, transport, session, presentation and application layers. A block level protocol works using a device or block level behavior at physical and data-link layers without involving any high-level layers including presentation or applications. Any application level protocol has to be customized for a given application. For example, a Microsoft Windows Operating System using Office applications will have different formatting and application requirements compared to an Apple Macintosh Computer. The blockchain platform provides flexibility to provide application level metadata that can be propagated by the parties to be used with raw application data for transactions.

In one embodiment, the application level protocol is a file level storage protocol. The filename is considered a metadata for the storage of a file. Files are named according to the hash of their contents. Directories contain hashes of their files, effectively acting like the inner nodes of a Merkle tree. Each commit is the root of a tree giving the current view of the file system.

In one embodiment, the file system structure is decided by the participating entity, including for example, a blobber or a client. The blockchain platform establishes rules and restrictions to promote appropriate behavior. Each file is stored with a name matching the cryptographic hash of its contents. Identical copies of the file are only stored once, each reference to a copy of the file in the file system points to the same hash value. Since the blobber would naturally store only a single file, we structure our compensation in this manner. The choice also protects against certain trivial generation attacks. For each directory, a file is stored that references the blobs that it contained any subdirectories. For each file the directory contains, the directory's metafile specifies: (i) the file name; (ii) the type of the file: directory or blob; (iii) the hash of the file contents, needed to refer to the corresponding blob/directory; (iv) the size of the file; (v) the Merkle root of the file contents (blobs only). For each blob, the write_marker for each block of the blob must be stored as well. With file storage, additional information about the path of the file needs to be specified in the marker. The new format of the read_marker signature is [READ, trans_id, blobber_id, file_path, block_num, i]_{client}. The format of the signature of the new write_marker is [WRITE, trans_id, blobber_id, hash(data), file_path, block_num, i]_{client}.

The has committed to the blockchain is no longer the Merkle root of the data. Instead, both the client and blobber write: hash(blob_list, blob_root, file_root). The blob_list is a list of all blobs stored and their size, stored by the blob name. By specifying this file, we can easily identify a single block to challenge with a single random number, where all blocks are equally likely to be selected. The format of this file is as follows: blob_name1, file_size1, blob_name2, file_size2, . . . . The blob_root is the Merkle root of the blobs, where very leaf is a blob hash. The order of the leaves is expected to match the order specified in blob_list. Finally, the file_root is the hash matching the root directory of the file system.

A person of ordinary skill in the art would understand that there are well-established methods and techniques to establish a secure digital connection between any two parties on the internet. The blockchain platform relies on the well-established methods to establish a secure connection with an added layer of security based on the role of the party i.e. the role of a client, a blobber, a sharder or a miner. Neither the client nor the blobber trust one another, yet the blockchain platform allows both parties acting in its own best interest to nonetheless benefit each other. Any transgressions can be identified by the mining network of the blockchain platform with one or miners having the authority to punish any misbehaving party.

A client may monitor for misbehaving blobber, sharder or miner. Similarly a blobber monitors for misbehaving client, sharder or miner. A sharder or miner monitors for misbehaving blobber or client. While there is no centralized supervising authority, everyone independently monitors for rule-based actions. Any suspicious activities outside the rule-based actions are monitored and reported. The blockchain platform framework retains it flexibility with distributed power and no single entity having authority or supervising powers.

Depending on different applications, the blockchain platform framework maps different rule-based actions as its underlying allowable actions or rules. A sharder or miner is involved in operations and administrative tasks. Some of the operational tasks involving generating tokens and rewarding payments for providing a service and receiving payment for using a service on the blockchain platform. In one embodiment, rule-based actions involve three-way handshake signals that verify the identity, integrity of the data and then allow for different application based transactional data. For example, a storage application, allows a read, write, update, edit or delete operations for application based data.

Different embodiments described herein include components or structures to perform the described functionality. A “component” or a “module” as used in this invention disclosure, includes a dedicated or shared processor and, typically, firmware or software modules executed by the processor. Depending upon implementation-specific or other considerations, a module can be centralized or its functionality distributed. A component or a module can include special purpose hardware, firmware, or software embodied in a computer-readable medium for execution by the processor.

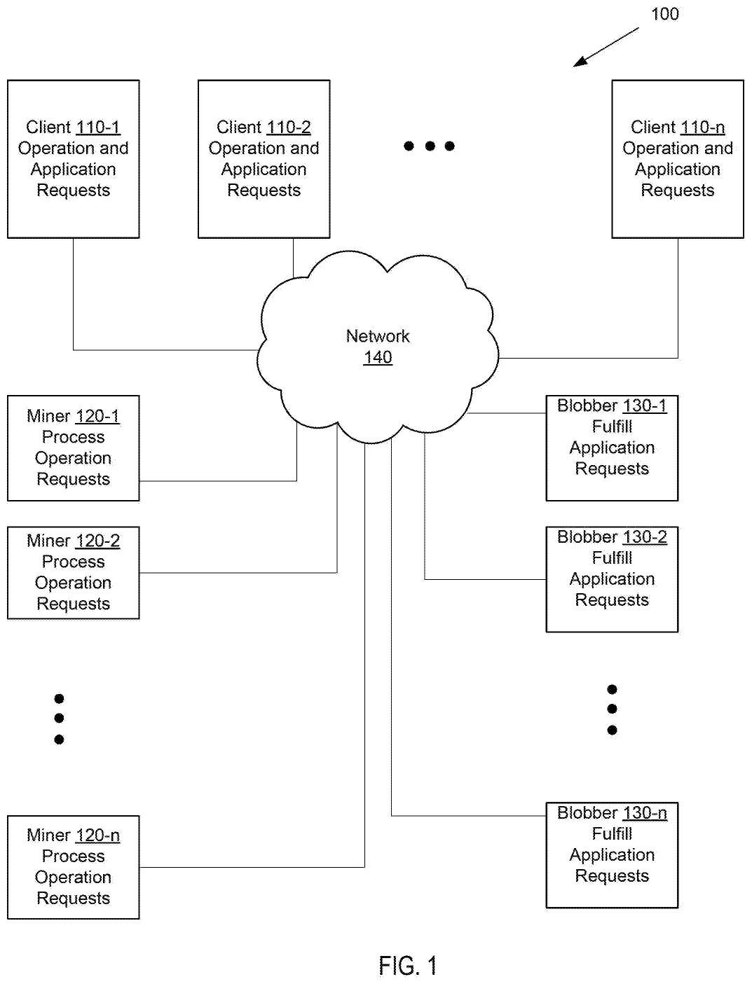

In one embodiment, FIG. 1 depicts a diagram 100 illustrating an example of a blockchain platform based on a message flow model for implementing different distributed applications. In the example of FIG. 1, the environment includes a first client system 110-1 through an nth client system 110-n, network 140, miner system 120-1 through an nth miner system 120-n and blobber system 130-1 through an nth blobber system 130-n. In an implementation, the client system 110 includes components related to operation (administrative) or application requests. In one implementation, the client system 110 includes application requests that are storage requests.

In one implementation, the miner 120 includes components to process operation requests from the clients. Two or more miners form a mining network. In one implementation, a sharder also is included in the mining network. In one implementation, the blobber 130 includes components to fulfill application requests that are initiated by the client 110 and approved by miner 120. The miner is only involved in the operations i.e. rewarding blobber or deducting payment for the services from a client. Blobber interacts with a miner as and when needed to commit transactions and get final audits for payments.

Network 140 can be different wireless and wired networks available to connect different computer devices including client and server systems. In an implementation, network 140 is publically accessible on the internet. In an implementation, network 140 is inside a secure corporate wide area network. In an implementation, network 140 allows connectivity of different systems and devices using a computer-readable medium. In an implementation, the blockchain platform allows users on the client system, the blobber or the miner to have customized applications and operational framework.

The messaging and notification between different components can be implemented using application programming interface (API) calls, extensible markup language (“XML”) interfaces between different interfaces, Java/C++ object oriented programming or simple web-based tools. Different components may also implement authentication and encryption to keep the data and the requests secure.

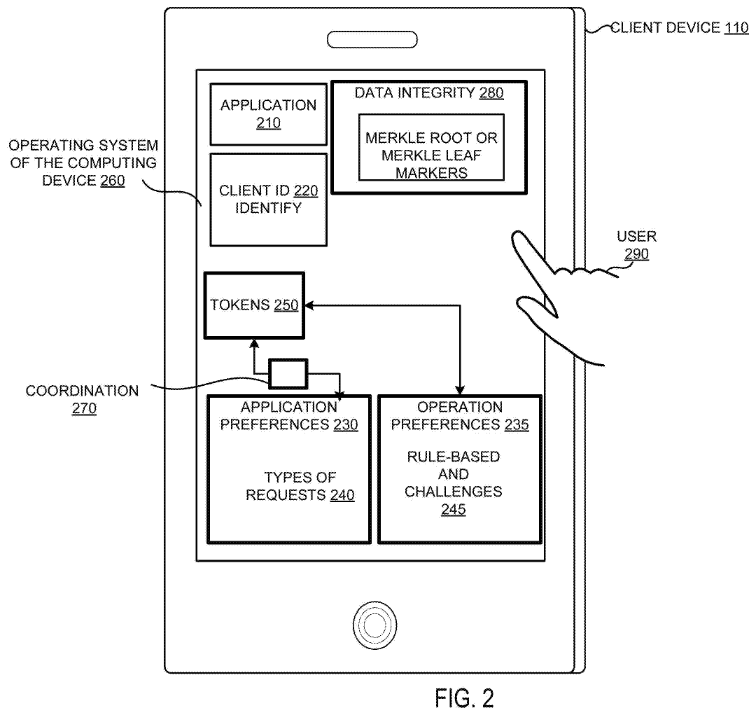

FIG. 2 is an exploded view of a client system 110 shown in FIG. 1. For a rule-based decentralized roles and control implementation, the client has an application 210 that interacts with the operating system 260 of the client computing device. The client uses a client_id 220 to perform identification of other entities interacting with it as well as provide its own identification. For example, a Diffie Hellman public and private cryptography keys to establish session keys. In one embodiment, the client and the blockchain platform uses Transport Layer Security, i.e. symmetric keys are generated for each transaction based on a shared secret negotiated at the beginning of a session. The client gets preauthorized tokens 250 for allocation on the blockchain platform. The application preferences for the client are coordinated using 270. A client's application preferences 230 include encryption, access times, preferred blobber or miner lists, etc. Types of requests 240 include application based lightning mode requests. The operational preferences 235 set the preferred modes of operation for payments and issuance of tokens or providing responses to challenges. The client is self-regulated using the rule-based and challenges action set 245.

The data integrity 280 includes techniques to create a unique numbers based on application data. It also serves the dual-purpose of catching cheaters on the blockchain platform and is self-regulating. Merkle root and Merkle tree (including Merkle leaves originating from the Merkle root) creation based on application data fragments and associated markers are used. Payments or rewards on the blockchain platform are based on the markers.

A client may use one or more options in different types of combinations to preserve data integrity 280 verification when sending data out on the system to different blobbers on the blockchain platform. In one implementation, the client has an option to create its own data_id for selected data. In one implementation, the client gets an automatically generated data_id based on different client preferences and parameters of usages. A user 290 is shown using the client device 110. In one implementation, the client system includes module to report errors when a blobber does not send an anticipated message. In one implementation, the client system monitors the blockchain for different suspicious activities related to its own work.

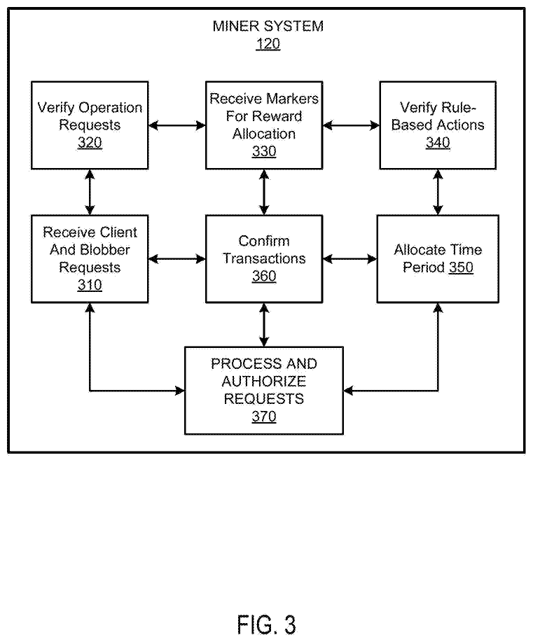

FIG. 3 is an exploded view of a miner system 120 of FIG. 1. The different components or modules included in a miner system includes a module to process and authorize requests 370, receive client and blobber requests 310, verify operation requests 320, receive markers for reward allocations 330, verify rule-based actions 340, allocate time period to complete the transaction 350, and confirm transaction 360 on the blockchain platform. In one implementation, the miner system includes module to implement the challenge protocol described earlier.

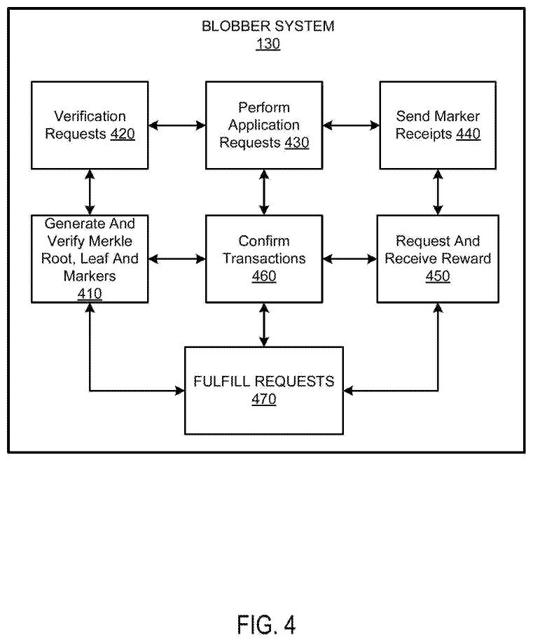

FIG. 4 is an exploded view of a blobber system 130 of FIG. 1. The different components or modules included in a miner system includes a module to fulfill requests 470, generate and verify Merkle root, Merkle leaf and markers 410, receive approved and verified requests 420, perform application requests 430, send marker receipts 440, request and receive award 450 and, confirm transactions 460. In one implementation, the blobber system separates out the operation tasks and application tasks and gives priority to responding back to application tasks. In one implementation, the blobber performs the operation tasks at the very end of the transaction. In one implementation, the blobber clubs two or more operation tasks to be performed at the very end of the work flow. In one implementation, the blobber selects a less busy time of the day to perform operation tasks.

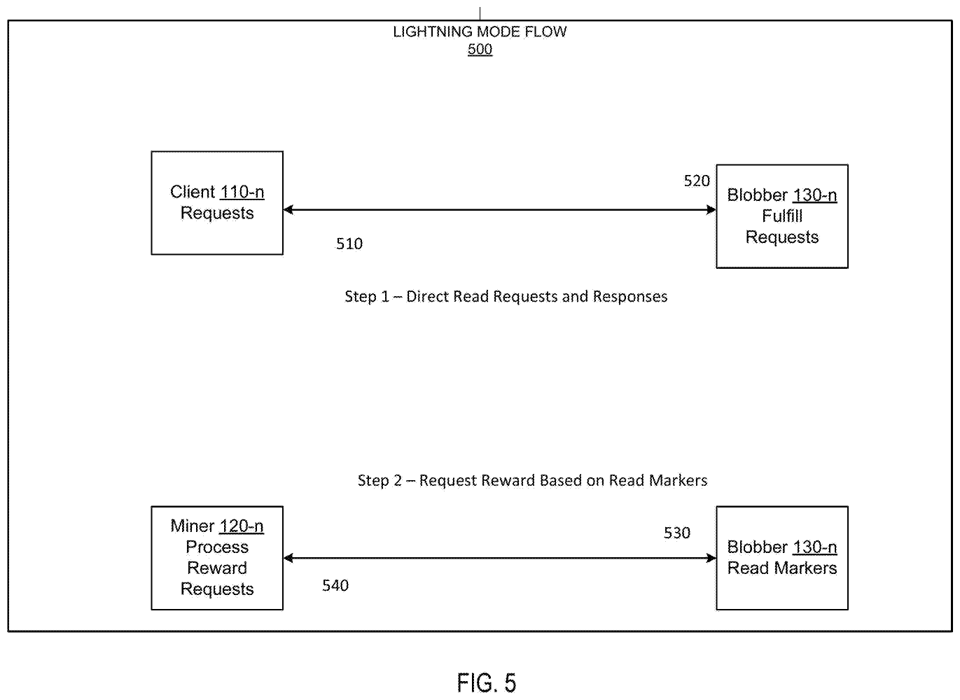

FIG. 5 shows the lightning mode interface that allows direct communication between a client and a blobber with the blobber sending read markers at the end of the transaction to a miner. For read-only transactions, a lightning mode allows clients to read from blobbers without first contacting the mining network. Special markers ensure that the blobbers are compensated for their work. Quick access is both a higher priority and less of a risk when in read-mode. In lightning mode, the client does not need to read an initial transaction to the network. The client knows the identity of the blobbers storing the data they desire. They may contact the blobber directly. In their initial message, they provide: (i) their own client_id; (ii) the trans_id of the transaction where they initially locked their tokens to get read_markers. This transaction allows the blobber to quickly verify the validity of the client's request. (iii) The client_id and data_id corresponding to the data that they wish to read. Note that this client_id is the ID of the owner, and may be different than the ID of the client currently requesting the data. After the connection is initialized, the client sends read_markers, following the process typically used for other transactions. Once the exchange is complete, the blobber writes a transaction to the blockchain to redeem the read_markers.

Since there is no initial transaction to the blockchain in lightning mode, there is a greater chance that the client may exceed their number of reads, particularly if the reads are for a large number of blobber simultaneously. When the blobber redeems the markers they have received, if they exceed the client's allocation of reads, the client's stake is seized to pay the blobber. However, once the client's stake has been exhausted, the blobber is not paid for any additional reads. This approach motivates blobbers to cash in their markers quickly, reducing the client's chances of success to cheat. Furthermore, it prevents the client and blobber from clouding to generate new tokens that exceed the client's seized stake.

The message 510 is a request and acknowledge between client 110 and blobber 130. The message 520 is a response to a client request 510 to respond to read requests from a blobber 130 to handle the client request in 510. The message 530 is the bidirectional message between blobber 130 and miner 120 to send read_markers and get paid for service of the read requests.

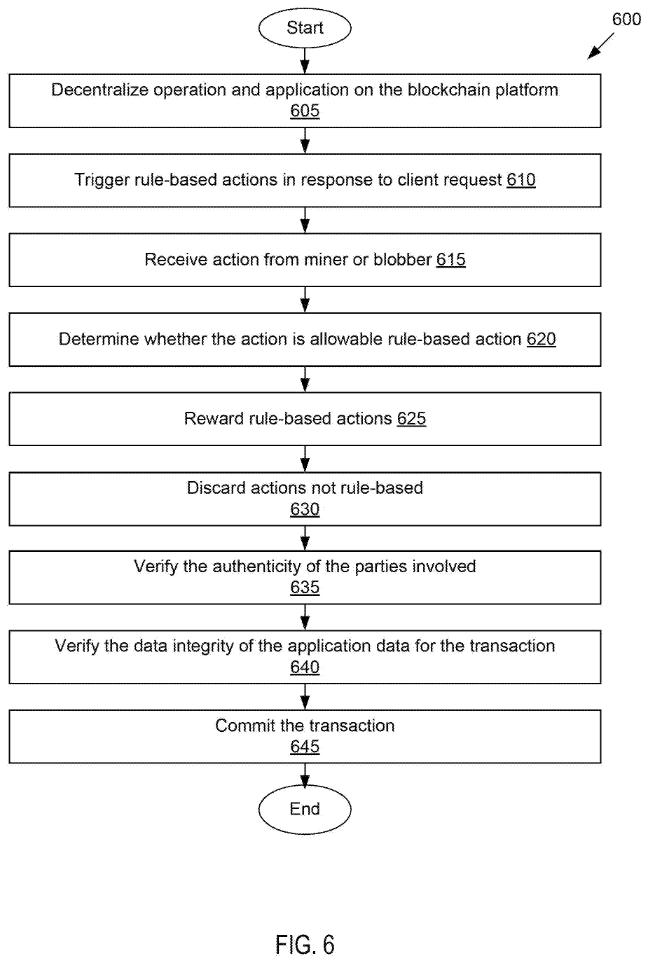

FIG. 6 depicts a flowchart 600 illustrating an example of a method for a blockchain platform with rule-based decentralized roles and control. The flowchart 600 is discussed in conjunction with the blockchain platform environment shown in the diagram 100 in FIG. 1. At block 605, for given transactions, the blockchain platform provides a framework to decentralize operation or administrative tasks and application tasks. At block 610, rule-based actions from a client, a blobber, a sharder or a miner trigger response to client request. At block 615, the blockchain platform receives a response to a client request trigger from a miner or a blobber. At block 620, the self-regulating blockchain's entities, client, blobber, sharder or miner determine whether the action is allowable rule-based action. For example, a client regulates a blobber or miner rule-based actions. In one embodiment, a blobber regulates a client or miner rule-based actions. At block 625, rewards are generated for servicing or processing using rule-based actions. At block 630, the blockchain framework discards actions that are not rule-based. At block 635, the authenticity of the parties involved is verified. At block 640, the data integrity of the application data for the transaction is verified. At block 645, the transaction is committed to the blockchain platform.

In broad embodiment, the invention is systems and methods of a blockchain platform for rule-based decentralized roles and control including self-regulating entities that do not have a central managing or supervising entity on the platform.

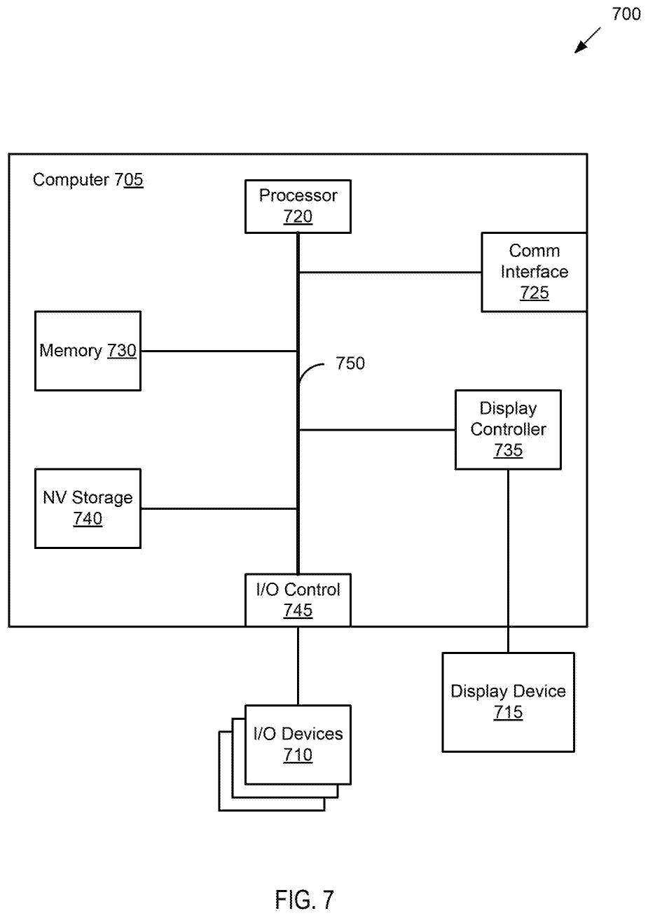

FIG. 7 is a schematic diagram of computing device 700 that can be used to implement the methods and systems disclosed herein, according to one or more embodiments. FIG. 7 is a schematic of a computing device 700 that can be used to perform and/or implement any of the embodiments disclosed herein. In one or more embodiments, client system 110, a miner system 120 and/or blobber system 130 of FIG. 1 may be the computing device 700.

The computing device 700 may represent various forms of digital computers, such as laptops, desktops, workstations, personal digital assistants, servers, blade servers, mainframes, and/or other appropriate computers. The computing device 700 may represent various forms of mobile devices, such as smartphones, camera phones, personal digital assistants, cellular telephones, and other similar mobile devices. The components shown here, their connections, couples, and relationships, and their functions, are meant to be exemplary only, and are not meant to limit the embodiments described and/or claimed.

FIG. 7 shows an example of a computing device 700 on which techniques described here can be implemented. The computing device 700 can be a conventional computer system that can be used as a client computer system, such as a wireless client or a workstation, or a server computer system. The computing device 700 includes a computer 705, I/O devices 710, and a display device 715. The computer 705 includes a processor 720, a communications interface 725, memory 730, display controller 735, non-volatile storage 740, and I/O controller 745. The computer 705 may be coupled to or include the I/O devices 710 and display device 715.

The computer 705 interfaces to external systems through the communications interface 725, which may include a modem or network interface. It will be appreciated that the communications interface 725 can be considered to be part of the computing device 700 or a part of the computer 705. The communications interface 725 can be an analog modem, integrated services for digital networks (“ISDN”) modem, cable modem, token ring interface, satellite transmission interface (e.g. “direct personal computer” also known as “direct PC”), or other interfaces for coupling a computer system to other computer systems.

The processor 720 may be, for example, a conventional microprocessor such as an Intel Pentium microprocessor or Motorola power PC microprocessor. The memory 730 is coupled to the processor 720 by a bus 750. The memory 730 can be Dynamic Random Access Memory (DRAM) and can also include Static RAM (SRAM). The bus 750 couples the processor 720 to the memory 730, also to the non-volatile storage 740, to the display controller 735, and to the I/O controller 745.

The I/O devices 710 can include a keyboard, disk drives, printers, a scanner, and other input and output devices, including a mouse or other pointing device. The display controller 735 may control in the conventional manner a display on the display device 715, which can be, for example, a cathode ray tube (CRT) or liquid crystal display (LCD). The display controller 735 and the I/O controller 745 can be implemented with conventional well-known technology.

The non-volatile storage 740 is often a magnetic hard disk, an optical disk, or another form of storage for large amounts of data. Some of this data is often written, by a direct memory access process, into memory 730 during execution of software in the computer 705. One of skill in the art will immediately recognize that the terms “machine-readable medium” or “computer-readable medium” includes any type of storage device that is accessible by the processor 720 and also encompasses a carrier wave that encodes a data signal.

The computing device 700 is one example of many possible computer systems that have different architectures. For example, personal computers based on an Intel microprocessor often have multiple buses, one of which can be an I/O bus for the peripherals and one that directly connects the processor 720 and the memory 730 (often referred to as a memory bus). The buses are connected together through bridge components that perform any necessary translation due to differing bus protocols.

Network computers are another type of computer system that can be used in conjunction with the teachings described here. Network computers do not usually include a hard disk or other mass storage, and the executable programs are loaded from a network connection into the memory 730 for execution by the processor 720. A Web TV system, which is known in the art, is also considered to be a computer system, but it may lack some of the components shown in FIG. 7, such as certain input or output devices. A typical computer system will usually include at least a processor, memory, and a bus coupling the memory to the processor.

Though FIG. 7 shows an example of the computing device 700, it is noted that the term “computer system,” as used here, is intended to be construed broadly. In general, a computer system will include a processor, memory, non-volatile storage, and an interface. A typical computer system will usually include at least a processor, memory, and a device (e.g., a bus) coupling the memory to the processor. The processor can be, for example, a general-purpose central processing unit (CPU), such as a microprocessor, or a special-purpose processor, such as a microcontroller. An example of a computer system is shown in FIG. 7.

The memory can include, by way of example but not limitation, random access memory (RAM), such as dynamic RAM (DRAM) and static RAM (SRAM). The memory can be local, remote, or distributed. As used here, the term “computer-readable storage medium” is intended to include only physical media, such as memory. As used here, a computer-readable medium is intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware.

The bus can also couple the processor to the non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

Software is typically stored in the non-volatile storage. Indeed, for large programs, it may not even be possible to store the entire program in the memory. Nevertheless, it should be understood that for software to run, if necessary, it is moved to a computer-readable location appropriate for processing, and for illustrative purposes, that location is referred to as the memory here. Even when software is moved to the memory for execution, the processor will typically make use of hardware registers to store values associated with the software, and local cache that, ideally, serves to speed up execution. As used here, a software program is assumed to be stored at an applicable known or convenient location (from non-volatile storage to hardware registers) when the software program is referred to as “implemented in a computer-readable storage medium.” A processor is considered to be “configured to execute a program” when at least one value associated with the program is stored in a register readable by the processor.

In one example of operation, a computer system can be controlled by operating system software, which is a software program that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus can also couple the processor to the interface. The interface can include one or more input and/or output (I/O) devices. The I/O devices can include, by way of example but not limitation, a keyboard, a mouse or other pointing device, disk drives, printers, a scanner, and other I/O devices, including a display device. The display device can include, by way of example but not limitation, a cathode ray tube (CRT), liquid crystal display (LCD), or some other applicable known or convenient display device. The interface can include one or more of a modem or network interface. It will be appreciated that a modem or network interface can be considered to be part of the computer system. The interface can include an analog modem, isdn modem, cable modem, token ring interface, satellite transmission interface (e.g. “direct PC”), or other interfaces for coupling a computer system to other computer systems. Interfaces enable computer systems and other devices to be coupled together in a network.

Several components described here, including clients, servers, and engines, can be compatible with or implemented using a cloud-based computing system. As used here, a cloud-based computing system is a system that provides computing resources, software, and/or information to client systems by maintaining centralized services and resources that the client systems can access over a communications interface, such as a network. The cloud-based computing system can involve a subscription for services or use a utility pricing model. Users can access the protocols of the cloud-based computing system through a web browser or other container application located on their client system.

The invention disclosure describes techniques that those of skill in the art can implement in numerous ways. For instance, those of skill in the art can implement the techniques described here using a process, an apparatus, a system, a composition of matter, a computer program product embodied on a computer-readable storage medium, and/or a processor, such as a processor configured to execute instructions stored on and/or provided by a memory coupled to the processor. Unless stated otherwise, a component such as a processor or a memory described as being configured to perform a task may be implemented as a general component that is configured to perform the task at a given time or a specific component that is manufactured to perform the task. As used here, the term ‘processor’ refers to one or more devices, circuits, and/or processing cores configured to process data, such as computer program instructions.

A detailed description of one or more implementations of the invention is provided here along with accompanying figures that illustrate the principles of the invention. The invention is described in connection with such implementations, but the invention is not limited to any implementation. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Techniques described here relate to apparatus for performing the operations. The apparatus can be specially constructed for the required purposes, or it can comprise a general-purpose computer selectively activated or reconfigured by a computer program stored in the computer. Such a computer program may be stored in a computer-readable storage medium, such as, but is not limited to, read-only memories (ROMs), random access memories (RAMS), EPROMs, EEPROMs, magnetic or optical cards, any type of disk including floppy disks, optical disks, CD-ROMs, and magnetic-optical disks, or any type of media suitable for storing electronic instructions, and each coupled to a computer system bus. Although the foregoing implementations have been described in some detail for purposes of clarity of understanding, implementations are not necessarily limited to the details provided.

A number of embodiments have been described. Nevertheless, it will be understood that various modifications may be made without departing from the spirit and scope of the claimed invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

It may be appreciated that the various systems, methods, and apparatus disclosed herein may be embodied in a machine-readable medium and/or a machine accessible medium compatible with a data processing system (e.g., a computer system), and/or may be performed in any order.

The structures and modules in the figures may be shown as distinct and communicating with only a few specific structures and not others. The structures may be merged with each other, may perform overlapping functions, and may communicate with other structures not shown to be connected in the figures.

The above-described functions and components may be comprised of instructions that are stored on a storage medium such as a computer readable medium. The instructions may be retrieved and executed by a processor. Some examples of instructions are software, program code, and firmware. Some examples of storage medium are memory devices, tapes, disks, integrated circuits, and servers. The instructions are operational when executed by the processor to direct the processor to operate in accord with some embodiments. Those skilled in the art are familiar with instructions, processor(s), and storage medium.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

A detailed description of one or more implementations of the invention is provided here along with accompanying figures that illustrate the principles of the invention. The invention is described in connection with such implementations, but the invention is not limited to any implementation. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

The structures and modules in the figures may be shown as distinct and communicating with only a few specific structures and not others. The structures may be merged with each other, may perform overlapping functions, and may communicate with other structures not shown to be connected in the figures.

1. A method on a blockchain platform, comprising:
de-centralizing a transaction on the blockchain by communicating separately with a miner for operation and a blobber for application;
inviting one or more rule-based actions to trigger the transaction from the miner or the blobber in response to a client request;
receiving an action from the miner or the blobber;
determining whether the action is one of the rule-based actions;
rewarding the rule-based action from the miner or the blobber;
discarding any action that is not rule-based;
committing the transaction after confirming authentication of all the entities and verifying data integrity for the transaction.

2. The method of claim 1, wherein the transaction involves lightning mode read request with direct response from the blobber; and requesting reward from the miner at the end of the transaction.

3. The method of claim 1, wherein verifying data integrity includes commitment of the same Merkle root or leaf of the same Merkle root by two separate computing entities.

4. The method of claim 1, wherein rewarding the rule-based action is based on a counter associated with the client and the blobber from the committed transaction.

5. The method of claim 1, further comprising:
receiving a challenge from one or more validators;
verifying the blobber or the miner action based on the verification response of the challenge;
self-regulating the transaction and the computing entities on the blockchain platform.

6. The method of claim 5, wherein the validator is a client.

7. The method of claim 1, wherein the transaction includes metadata for an associated application.

8. The method of claim 7, wherein the metadata includes metadata for a file system.

9. The method of claim 7, further comprising browsing the metadata for the associated application to lookup the transaction data.

10. The method of claim 1, further comprising:
receiving a request from the client to re-assign a blobber from the committed transaction;
committing a re-assigned transaction after confirming authentication of all computing entities and verifying data integrity for the transaction.

11. A system on a blockchain platform, comprising:
a de-centralized transaction module on the blockchain by communicating separately with a miner for operation and a blobber for application;
an invitation module to invite one or more rule-based actions to trigger the transaction from the miner or the blobber in response to a client request;
a receiving module to receive an action from the miner or the blobber;
a determining module to determine whether the action is one of the rule-based actions;
a rewarding module to reward the rule-based action from the miner or the blobber;
a discarding module to discard any action that is not rule-based;
a commitment module to commit the transaction after confirming authentication of all the entities and verifying data integrity for the transaction.

12. The system of claim 11, wherein the transaction involves lightning mode read request with direct response from the blobber; and requesting reward from the miner at the end of the transaction.

13. The system of claim 11, wherein verifying data integrity includes commitment of the same Merkle root or leaf of the same Merkle root by two separate computing entities.

14. The system of claim 11, wherein rewarding the rule-based action is based on a counter associated with the client and the blobber from the committed transaction.

15. The system of claim 11, further comprising:
a receiving module to receive a challenge from one or more validators;
a verification module to verify the blobber or the miner action based on the verification response of the challenge;
a self-regulation module to self-regulate the transaction and the computing entities on the blockchain platform.

16. The system of claim 15, wherein the validator is a client.

17. The system of claim 11, wherein the transaction includes metadata for an associated application.

18. The system of claim 17, wherein the metadata includes metadata for a file system.

19. The system of claim 17, further comprising a module to browse the metadata for the associated application to lookup the transaction data.

20. The system of claim 11, further comprising:
a receive module to receive a request from the client to re-assign a blobber from the committed transaction;
a commitment module to commit a re-assigned transaction after confirming authentication of all computing entities and verifying data integrity for the transaction.
